(19) United States
(12) Patent Application Publication
(10) Pub. No.: US 2026/0276972 A1
(43) Pub. Date: Sep. 17, 2026

(54) MULTIMODE FOCUSER FOR ASTRONOMICAL TELESCOPE

(71) Applicant: Nanjing iOptron Astronomy S&T, Ltd., Nanjing (CN)

(72) Inventors: Ning Xu, Nanjing (CN); Yonglie Jiao, Nanjing (CN); Hua Jiang, Sharon, MA (US)

(21) Appl. No.: 19/563,826

(22) Filed: Mar. 11, 2026

Related U.S. Application Data
(60) Provisional application No. 63/772,120, filed on Mar. 14, 2025.

(51) Int. Cl. G02B 23/06; G02B 7/10

(52) U.S. Cl. CPC G02B 23/06; G02B 7/102

(57) ABSTRACT

A focuser for a telescope enables direct electric, controller-based, and manual modes of operation simultaneously. The focuser includes one or more electronic focus buttons, an electronic control port, and a manual focusing knob, allowing three simultaneously available focusing modes. For example, an operator can readily adjust the focus of an image using the button(s), control the focus via the control port using software or a separate control unit, and refine the focus using the manual knob. These focusing modes can be operated in any order and without having to change any physical configuration of the focuser, such as couplers or installation adapter plates.

### CROSS-REFERENCE TO RELATED APPLICATIONS

This application claims the benefit of U.S. Provisional Application No. 63/772,120 , filed Mar. 14, 2025, the contents and teachings of which are incorporated by reference herein in their entirety.

### BACKGROUND

The present invention relates generally to astronomical instruments, and more particularly to a focuser used in astronomical telescopes for observations and astrophotography.

A “focuser” is a mechanical device for adjusting the focus of a telescope. A typical focuser includes a base and a focusing barrel configured to move within the base. The base of the focuser is attached to the telescope near its focal plane, and the focusing barrel is adapted to receive an eyepiece or camera. The focuser enables controlled movement of the focusing barrel back and forth within the base for achieving a clear image. Typically, a complex rack and pinion system drives the focusing barrel, and/or an electric drive may be used for precise and/or hands-free adjustments.

In certain prior focuser designs, components for electronic focusing and manual focusing are kept separate, and the components are connected via couplers and installation adapter plates. Examples of such focuser designs include the EAF (electric automatic focuser) available from ZWO of Suzhou, China, and the AAF (astro automatic focuser) available from ToupTek of Hangzhou, Zhejiang Province, China.

### SUMMARY

Certain embodiments are directed to a focuser for a telescope. The focuser includes a base attached to the telescope, a focusing barrel adapted to receive an eyepiece or camera, and a multimode control assembly attached to or integral with the base. The multimode control assembly includes a set of buttons, an electronic control port, and a focusing knob, the multimode control assembly constructed and arranged to move the focusing barrel back and forth relative to the base (i) in a first mode responsive to operation of the set of buttons, (ii) in a second mode responsive to commands received via the electronic control port, and (iii) in a third mode responsive to manual operation of the focusing knob.

Other embodiments are directed to a telescope that includes a tube that houses a light-collecting element and a focuser arranged to receive and focus light from the light-collecting element. The focuser includes a base attached to the telescope, a focusing barrel adapted to receive an eyepiece or camera, and a multimode control assembly attached to or integral with the base. The multimode control assembly includes a set of buttons, an electronic control port, and a focusing knob, the multimode control assembly constructed and arranged to move the focusing barrel back and forth relative to the base (i) in a first mode responsive to operation of the set of buttons, (ii) in a second mode responsive to commands received via the electronic control port, and (iii) in a third mode responsive to manual operation of the focusing knob.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views. The drawings are not necessarily to scale, emphasis instead being placed upon illustrating the principles of various embodiments.

FIG. 1 is a perspective view of an example focuser according to one or more embodiments.

FIG. 2 is an exploded, perspective view of the focuser of FIG. 1, according to one or more embodiments.

FIG. 3 is a partially transparent, isometric view of the focuser of FIG. 1, according to one or more embodiments.

FIG. 4 is an isometric view of the focuser of FIG. 1, according to one or more embodiments.

FIG. 5 is a perspective view of a telescope that includes a focuser according to one or more embodiments.

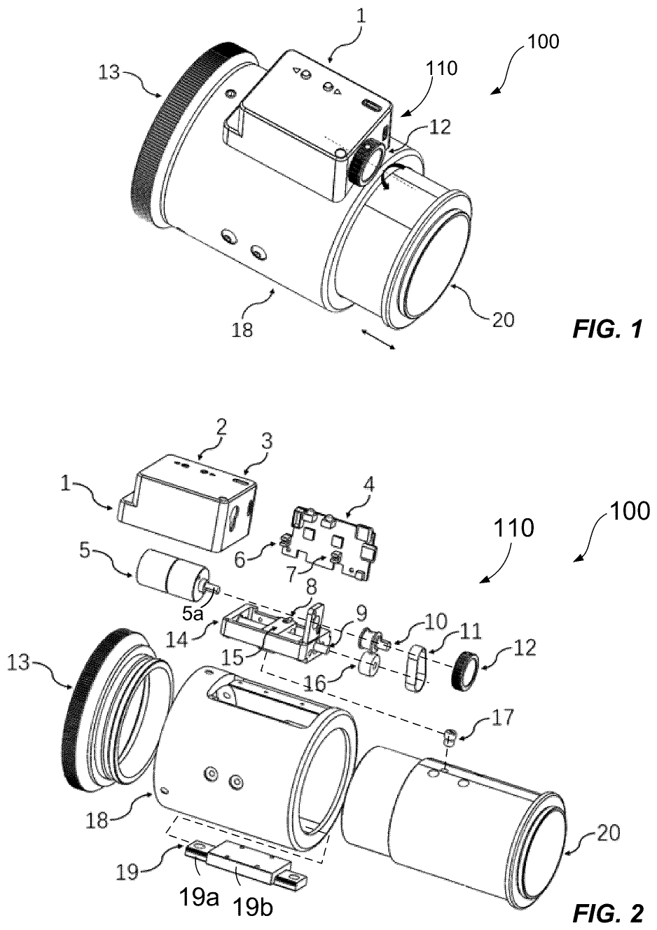

### DETAILED DESCRIPTION

The above-described prior focuser designs have deficiencies. For example, once an electronic focusing mechanism is installed in the prior designs, the manual focusing mechanism is no longer available, making focusing adjustments more difficult. In addition, the prior designs arrange an axis of the focuser's motor to be perpendicular to the axis of movement of the focusing barrel. Owing to the substantial weight of cameras and telescope eyepieces, the perpendicular arrangement of the motor and focusing barrel can cause a shift in the telescope's center of mass as the focusing barrel moves. In an equatorial mount, this shift can disrupt the balance of the mount's declination axis, leading to reduced tracking accuracy. Further, the size and weight of these systems make them inconvenient for astronomical observations and photography.

The above issues with the prior focuser designs are addressed at least in part with an improved focuser that enables direct electric, controller-based, and manual modes of operation simultaneously. The focuser includes one or more electronic focus buttons, an electronic control port (e.g., USB-C), and a manual focusing knob, allowing three simultaneously available focusing modes and increasing ease of use. For example, an operator can readily adjust the focus of an image using the button(s), control the focus via the control port using software or a separate control unit, and refine the focus using the manual knob. These focusing modes can be operated in any order and without having to change any physical configuration of the focuser, such as couplers or installation adapter plates.

According to one or more embodiments, the focuser includes a motor having a motor shaft. The motor shaft has a geared connection to a drive screw, which is configured to rotate in response to rotation of the motor shaft and to move a focusing barrel of the focuser back and forth within a focuser base, which may be attached to the telescope. A manual focus knob is coupled to the motor shaft to enable manual focusing, e.g., when the motor is inactive. The focuser includes electronic control circuitry constructed and arranged to respond to button presses of the button(s), and to focusing commands received over the control port, to activate the motor to rotate the motor shaft and therefore the drive screw. The three control modes can thus control the drive screw independently, causing the focusing barrel to move correspondingly.

According to one or more embodiments, the focuser adopts an integrated design that aligns a focusing motor and drive screw parallel to the telescoping direction of the focusing barrel, reducing size and weight as well as undesirable shifts in center of mass as the focusing barrel is moved.

Embodiments of the improved technique will now be described. One should appreciate that such embodiments are provided by way of example to illustrate certain features and principles but are not intended to be limiting.

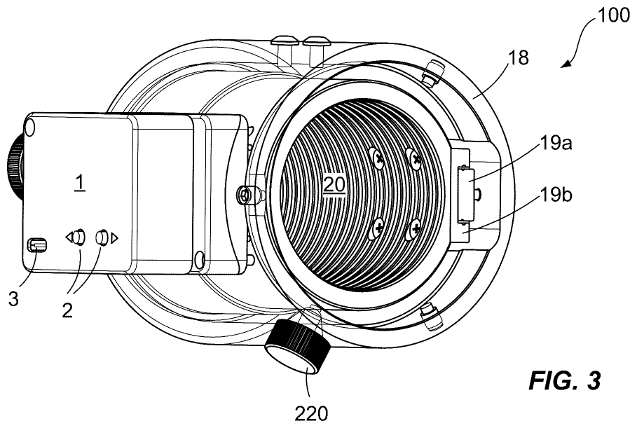

Referring to the accompanying figures, a focuser (100) according to one or more embodiments includes a focuser base/main tube (18) equipped with a linear bearing (19; FIG. 2). The linear bearing (19) includes a rail (19a) attached to the base (18) and a linear guider bearing (19b) attached to the focuser drawtube (20). The linear guider bearing (19b) is disposed to slide back and forth within a channel of the rail (19a), thus enabling the drawtube (20) to slide back and forth in a linearly constrained manner relative to the base (18).

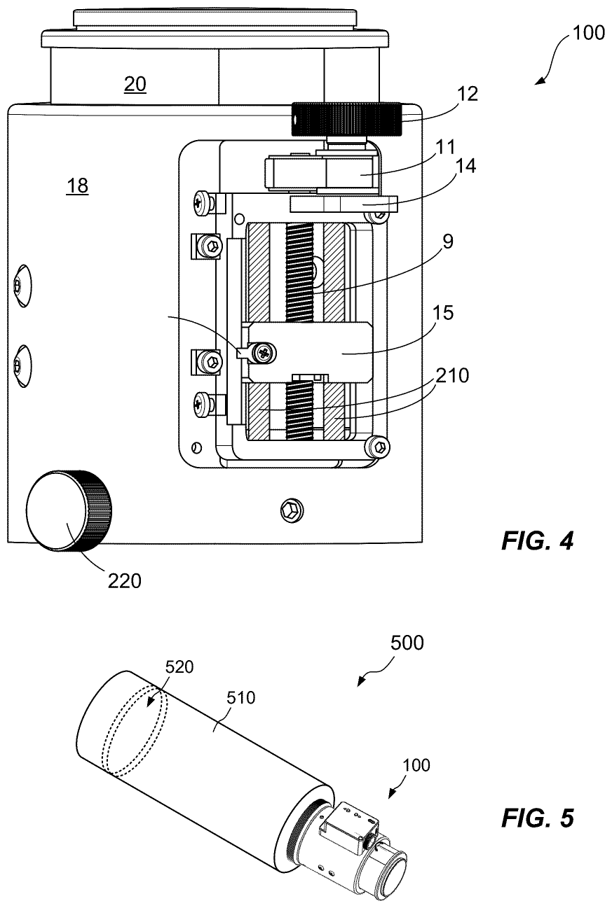

A multimode control assembly (110) is attached to the focuser base (18) and includes a transmission support frame (14; FIG. 2), which contains a captive drive screw (9) threaded through a sliding block (15). As the drive screw (9) rotates one way and the other, the sliding block (15) linearly translates forward and back along the drive screw (9). In some examples, the transmission support frame (14) further includes first and second side rails (210; FIG. 4), which run parallel to the drive screw (9), prevent the sliding block (9) from rotating, and keep the sliding block (15) precisely perpendicular to the drive screw (9).

A focusing drawtube connection screw (17) is screwed into the focus drawtube (20), and a head of the screw (17) is engaged with an underside of the sliding block (15). For example, the head of the screw (17) fits tightly within a hole (not shown) in the underside of the sliding block (15). With this arrangement, back and forth movement of the sliding block (15), which results from rotation of the drive screw (9), causes the drawtube (20) to slide back and forth relative to the base (18) on the linear rail (19).

A drive screw synchronous pulley (16) is attached at an end of the drive screw (9). A focus motor (5) is mounted parallel to the drive screw (9) in the transmission support frame (14). An output shaft (5a) of the focus motor (5) is attached to a motor pulley (10), which is coupled to the drive screw synchronous pulley (16) by a synchronous belt (11). In the example shown, the motor pulley (10) is arranged coaxially with the motor shaft (5a) and includes a central shaft adapted to receive a focusing knob (12). Alternatively, the motor shaft (5a) may extend through and frictionally engage the motor pulley (10), with the knob (12) applied directly to the end of the motor shaft (5a). Other arrangements are possible. For example, the focusing knob (12) may be attached directly to an end of the drive screw (9), or it may have a geared attachment to the drive screw (9) or motor shaft (5a), e.g., for fine manual focus.

The transmission support frame (14) is mounted on the focuser main tube (18). Control circuitry, such as a focuser control circuit board (4), is electrically connected to the motor (5) and attached to a motor cover (1) of the focuser (100), and the motor cover (1) is fastened to the base (18). The motor cover (1) thus covers and protects the entire multimode control assembly (110).

The focuser control circuit board (4) is equipped with two electric focusing buttons (2), e.g., for activating forward and backward motion, and an electronic control port (3), such as USB-C. Two separate USB-C ports may be provided, for ease of access. In some examples, the sliding block (15) has a blade or pin (8) and the focuser control circuit board (4) is further equipped with first and second LED detectors/sensors (6) and (7), which detect close proximity of the sliding blade or pin (8). Such detection enables the focuser control circuit board (4) to detect and limit extreme excursions of the drawtube (20) and thus prevent focusing overruns.

A telescope connection ring (13) may be mounted to a front of the focusing main seat (18). In some examples, the focuser (100) is constructed and arranged to rotate the connection ring (13) for providing a CAA (camera angle adjuster). For example, the CAA enables rotation of a rectangular field of view as seen by a camera attached to the focuser (100), to provide better framing of objects being photographed. A knob (220) (FIG. 4) and associated gearing may be provided for manually rotating the telescope connection ring (13). In some examples, the knob (220) is replaced or augmented with an electric motor (not shown), which may also be mounted parallel to the base (18) and may be housed under the same cover (1) as the multimode control assembly (110), or elsewhere. In addition to improving framing of objects, the motorized version of the CAA also enables precise rotation of the focuser (100) to compensate for field rotation, an inherent issue in telescopes having alt-azimuth mounts.

With the depicted arrangement, the motor (5) and drive screw (9) run parallel to the main axis of the focuser (100), rather than perpendicularly, and extend only a short transverse distance away from the base (18), limiting any imbalance caused by off-axis weight, and in particular limiting imbalance about an equatorial mount's declination axis. Further, the placement of the linear rail (19) opposite the multimode control assembly (110) provides a measure of inherent counterbalancing, as the weight of the linear rail (19) at least partially offsets the weight of the multimode control assembly (110).

In addition, the focuser (100) seamlessly blends button actuated, electronic control (e.g., via USB-C), and manual focusing modes. Both the knob (12) and the motor (5) are coupled to the same drive screw (9), enabling both the knob (12) and the motor (5) to adjust the focuser via the same drive train. Motor control does not disable manual control, nor does manual control disable motor control. The motor (5) may be driven by pressing the buttons (2) or based on electronic control via the control port 3. Such electronic control enables automatic focusing by a suitable software application or separate controller, as well as touch-free electronic focusing.

The present invention provides three effective focusing control methods. The first method involves pressing or holding the electric focusing buttons (2) to send control signals to the focuser control circuit board (4), which then controls the focus motor (5) to move the focuser drawtube (20) back and forth. The second method uses a computer or astronomical control box to send control signals to the focuser control circuit board (4) via the Type-C control port (3). The focuser control circuit board (4) responds to the control signals by directing the focus motor (5) to move the focus drawtube (20) back and forth. The third method involves manually rotating the manual focus knob (12), which drives the focuser drawtube (20) back and forth.

FIG. 5 shows an example telescope 500 according to one or more embodiments. The telescope 500 includes a tube 510 that houses a light-collecting element 520, such as a lens or mirror (lens depicted), and a focuser, such as the focuser 100 described above. The focuser 100 is arranged to receive and focus light from the light-collecting element 520. Although no telescope stand is shown, one should appreciate that the telescope 500 may include a tripod or other stand, as well as a mount, such as an equatorial mount or an alt-azimuth mount. Also, although FIG. 5 depicts a refracting telescope, this is just an example, and the focuser 100 may also be used in reflecting telescopes and in catadioptric telescopes.

Having described certain embodiments, numerous alternative embodiments or variations can be made. Further, although features have been shown and described with reference to particular embodiments hereof, such features may be included and hereby are included in any of the disclosed embodiments and their variants. Thus, it is understood that features disclosed in connection with any embodiment are included in any other embodiment.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Further, although the term “user” as used herein may refer to a human being, the term is also intended to cover non-human entities, such as robots, bots, and other computer-implemented programs and technologies. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the following claims.

What is claimed is:

1. A focuser for a telescope, comprising:
a base adapted to attach to the telescope;
a focusing barrel adapted to receive an eyepiece or camera; and
a multimode control assembly attached to or integral with the base, the multimode control assembly including a set of buttons, an electronic control port, and a focusing knob, the multimode control assembly constructed and arranged to move the focusing barrel back and forth relative to the base (i) in a first mode responsive to operation of the set of buttons, (ii) in a second mode responsive to commands received via the electronic control port, and (iii) in a third mode responsive to manual operation of the focusing knob.

2. The focuser of claim 1, wherein the first mode, the second mode, and the third mode are simultaneously available for moving the focusing barrel back and forth relative to the base.

3. The focuser of claim 1, further comprising a linear bearing having a first part attached to the base and a second part attached to the focusing barrel, the linear bearing constructed and arranged to enable linearly constrained movement of the focusing barrel relative to the base.

4. The focuser of claim 3, wherein the linear bearing is disposed on a side of the focusing barrel opposite the multimode control assembly to partially counterbalance a weight of the multimode control assembly.

5. The focuser of claim 3, wherein the multimode control assembly further includes:
control circuitry electrically coupled to the set of buttons and to the electronic control port;
a motor electrically coupled to the control circuitry, the motor having a motor shaft and arranged to rotate the motor shaft in response to a set of control signals from the control circuitry; and
a drive train coupled between the motor shaft and the focusing barrel, the drive train constructed and arranged to move the focusing barrel along the linear bearing in response to rotation of the motor shaft.

6. The focuser of claim 5, wherein the motor shaft is parallel to the focusing barrel.

7. The focuser of claim 5, wherein the focusing knob is mechanically coupled to the motor shaft.

8. The focuser of claim 7, wherein the drive train includes:
a drive screw mechanically coupled to the motor shaft;
a sliding block threaded with the drive screw and engaged with the focusing barrel, the sliding block arranged to move the focusing barrel along the linear bearing in response to rotation of the drive screw.

9. The focuser of claim 8, wherein the sliding block has a pin, and wherein the control circuitry includes first and second LED (light emitting diode) sensors constructed and arranged to detect extreme excursions of the focuser barrel relative to the base based on proximity of the pin the LED sensors.

10. The focuser of claim 3, further comprising a connection ring arranged to connect the base of the focuser to the telescope, the connection ring being rotatable relative to the base for rotating a rectangular field of view visible to a camera attached to the focusing barrel.

11. The focuser of claim 10, further comprising a knob for manually rotating the connection ring relative to the base.

12. The focuser of claim 10, further comprising a motor for electronically rotating the connection ring relative to the base.

13. A telescope, comprising:
a tube that houses a light-collecting element; and
a focuser arranged to receive and focus light from the light-collecting element, the focuser including:
a base attached to the telescope;
a focusing barrel adapted to receive an eyepiece or camera; and
a multimode control assembly attached to or integral with the base, the multimode control assembly including a set of buttons, an electronic control port, and a focusing knob, the multimode control assembly constructed and arranged to move the focusing barrel back and forth relative to the base (i) in a first mode responsive to operation of the set of buttons, (ii) in a second mode responsive to commands received via the electronic control port, and (iii) in a third mode responsive to manual operation of the focusing knob.

14. The telescope of claim 13, wherein the first mode, the second mode, and the third mode are simultaneously available for moving the focusing barrel back and forth relative to the base.

15. The telescope of claim 13, wherein the focuser further includes a linear bearing having a first part attached to the base and a second part attached to the focusing barrel, the linear bearing constructed and arranged to enable linearly constrained movement of the focusing barrel relative to the base.

16. The telescope of claim 15, wherein the linear bearing is disposed on a side of the focusing barrel opposite the multimode control assembly to partially counterbalance a weight of the multimode control assembly.

17. The telescope of claim 15, wherein the multimode control assembly further includes:
control circuitry electrically coupled to the set of buttons and to the electronic control port;
a motor electrically coupled to the control circuitry, the motor having a motor shaft and arranged to rotate the motor shaft in response to a set of control signals from the control circuitry; and
a drive train coupled between the motor shaft and the focusing barrel, the drive train constructed and arranged to move the focusing barrel along the linear bearing in response to rotation of the motor shaft.

18. The telescope of claim 17, wherein the motor shaft is parallel to the focusing barrel.

19. The telescope of claim 17, wherein the focusing knob is mechanically coupled to the motor shaft.

20. The telescope of claim 19, wherein the drive train includes:
a drive screw mechanically coupled to the motor shaft;
a sliding block threaded with the drive screw and engaged with the focusing barrel, the sliding block arranged to move the focusing barrel along the linear bearing in response to rotation of the drive screw.
